(19) United States
(12) Patent Application Publication
(10) Pub. No.: US 2016/0101772 A1
(43) Pub. Date: Apr. 14, 2016

(54) TRAVEL CONTROL APPARATUS OF HYBRID VEHICLE

(71) Applicant: TOYOTA JIDOSHA KABUSHIKI KAISHA, Toyota-shi, Aichi-ken (JP)

(72) Inventor: Eiji MAEDA, Fuji-shi (JP)

(73) Assignee: TOYOTA JIDOSHA KABUSHIKI KAISHA, Toyota-shi, Aichi-ken (JP)

(21) Appl. No.: 14/778,268

(22) PCT Filed: Apr. 10, 2013
(86) PCT No.: PCT/JP13/60858

§ 371 Date: Sep. 18, 2015

(51) Int. Cl. B60W 20/00; B60W 10/08; B60W 10/06

(52) U.S. Cl. CPC B60W 20/10; B60W 10/06; B60W 10/08

(57) ABSTRACT

A travel control apparatus applied in a hybrid vehicle is provided with: a planetary gear mechanism capable of distributing power of an internal combustion engine to a first MG and an output unit, and a second MG capable of outputting power to the output unit. When a requested output to the internal combustion engine is zero, rotational speed control for controlling the first MG is executed so that the rotational speed of the internal combustion engine is higher than zero when the speed of the vehicle is equal to or greater than a predetermined control determination speed, and the execution of rotational speed control is prohibited when the speed of the vehicle is less than the control determination speed.

### TECHNICAL FIELD

The present invention relates to a travel control apparatus that is applied to a hybrid vehicle which is capable of allocating the power of an internal combustion engine between a first motor-generator and drive wheels with a differential mechanism, and that moreover is capable of outputting the power of a second motor-generator to the drive wheels, and is capable of making the vehicle perform accelerating-coasting traveling in which accelerating traveling and coasting traveling are alternately repeated within a predetermined vehicle speed range.

### BACKGROUND ART

A hybrid vehicle is per se known that is capable of allocating the power of an internal combustion engine between a first motor-generator and drive wheels via a differential mechanism such as a planetary gear mechanism or the like, and that is moreover capable of outputting the power of a second motor-generator to the drive wheels. And, as a control apparatus for such a vehicle, a control apparatus is per se known that is capable of controlling the vehicle to travel according to so-called accelerating-coasting traveling in which accelerating traveling in which the drive wheels are driven by the power of the internal combustion engine so that the vehicle is accelerated, and coasting traveling in which the internal combustion engine is stopped and the vehicle is allowed to coast onward due to its inertia, are repeatedly performed within a predetermined vehicle speed range. When, for example, the thermal efficiency of the internal combustion engine is to be considered, a control apparatus is per se known (refer to Patent Document #1) which makes the vehicle perform the accelerating-coasting traveling rather than makes the internal combustion engine operate continuously at low load, and also makes the vehicle perform the accelerating-coasting traveling when the fuel consumption is enhanced because the internal combustion engine is operated at high load during the accelerating traveling of the accelerating-coasting traveling. With the apparatus of this Patent Document #1, the output fluctuations that are generated when the internal combustion engine is repeatedly operated and stopped are compensated with the second motor-generator. And, apart from the above, Patent Document #2 in the Citation List may be considered to have some relevance to the present invention.

### CITATION LIST

### Patent Literature

Patent Document #1: JP-A-2010-006309.

Patent Document #2: JP-B-4,991,555.

### SUMMARY OF INVENTION

### Technical Problem

With a hybrid vehicle such as the one shown in Patent Document #1, various operational states are established during traveling, such as power recirculating traveling in which, while the first motor-generator is generating electricity, this electrical power is being consumed by the second motor-generator, and high speed traveling and so on. In view of the fact that these various operational states may occur, there is a danger that the energy efficiency of the vehicle will not be improved if the internal combustion engine and the motor-generators are not controlled with consideration being given to losses in the motor-generators and so on, as well as to the thermal efficiency of the internal combustion engine.

Thus, the object of the present invention is to provide a travel control apparatus for a hybrid vehicle that can improve the overall energy efficiency of the vehicle.

### Solution to Technical Problem

A travel control apparatus as one aspect of the present invention is a travel control apparatus applied to a hybrid vehicle, the hybrid vehicle comprising: an internal combustion engine; a first motor-generator; an output unit for transmitting power to a drive wheel; a differential mechanism comprising three rotating elements which are mutually differentially rotatable, with, among the three rotating elements, a first rotating element being connected to the internal combustion engine, a second rotating element being connected to the first motor-generator, and a third rotating element being connected to the output unit; and a second motor-generator which is capable of outputting power to the output unit, wherein the travel control apparatus comprises a control device which is configured to, when requested output to the internal combustion engine is zero: if speed of the vehicle is greater than or equal to a predetermined control determination speed, control the first motor-generator by executing rotational speed control so that the rotational speed of the internal combustion engine is higher than zero; and, if the speed of the vehicle is less than the predetermined control determination speed, control the first motor-generator so that execution of the rotational speed control is prohibited.

With this vehicle, in order to keep the rotational speed of the internal combustion engine at zero in high speed traveling, it is necessary for the rotational speed of the first motor-generator to be high. As is per se known, with a motor-generator, magnetism is generated by the rotor when the rotor rotates. Since the rotor is braked by this magnetism, accordingly an energy loss occurs in the motor-generator. And this magnetism becomes greater, the higher the rotational speed of the rotor becomes. Apart from the above, with a motor-generator, mechanical losses occur due to friction losses generated in its mechanical portions such as the bearings and so on, and stirring losses are also generated when the cooling oil of the motor-generator is stirred. And these mechanical losses and stirring losses also become greater, the higher is the rotational speed of the rotor. Moreover, with a per se known differential mechanism, the frictional losses become greater, the greater the differences in rotational speeds between the various rotating elements become. Due to this, if the rotational speed of the internal combustion engine is kept at zero in high speed traveling, the energy losses in the motor-generators and the energy loss in the differential mechanism become great. By contrast, when the rotational speed control is executed and the rotational speed of the internal combustion engine is kept higher than zero, while friction losses occur in the internal combustion engine, on the other hand the energy losses in the motor-generators, the mechanical losses, the stirring losses, and the energy loss in the differential mechanism all become smaller. Due to this, when the vehicle speed becomes high, in some cases, the energy losses in the vehicle as a whole when the rotational speed control is executed may become smaller than the energy losses in the vehicle when the rotational speed control is not executed. With the travel control apparatus of the present invention, it is possible to reduce the energy losses in the vehicle as a whole during high speed traveling, since the rotational speed control is executed when the speed of the vehicle is higher than the control determination speed. Due to this, it is possible to improve the overall energy efficiency of the vehicle as a whole.

In one embodiment of the travel control apparatus of the present invention, the control determination speed may be set to a speed at which energy loss of the vehicle occurring when the rotational speed control is not executed is greater than energy loss of the vehicle occurring when the rotational speed control is executed. It is possible to improve the overall energy efficiency of the vehicle in an appropriate manner by setting this type of speed for the control determination speed.

In another embodiment of the travel control apparatus of the present invention, there may be further included an accelerating-coasting travel device which is configured to control the internal combustion engine, the first motor-generator, and the second motor-generator so that, if a predetermined accelerating-coasting travel condition becomes valid when the vehicle is traveling, the vehicle travels in an accelerating-coasting travelling mode in which accelerating traveling in which the internal combustion engine is put into an operational state at which the vehicle is accelerated with power outputted from the internal combustion engine so that the rotational speed of the first motor-generator becomes zero, and coasting traveling in which the internal combustion engine is put into a stopped state and the vehicle is allowed to travel under inertia, are performed repeatedly and alternatingly within a predetermined target vehicle speed region; and wherein the control device may be further configured to control the first motor-generator so that the rotational speed control is executed when the speed of the vehicle in the coasting traveling is greater than or equal to the control determination speed, and so that execution of the rotational speed control is prohibited when the speed of the vehicle in the coasting traveling is less than the control determination speed. In this case, it is possible to reduce the energy loss during the coasting traveling. And, due to this, it is possible to increase the distance that the vehicle can travel during the coasting traveling. Accordingly, it is possible to improve the fuel consumption.

In the above embodiment, a rotational speed display device which displays the rotational speed of the internal combustion engine may be provided to the vehicle; and the control device may be further configured to set the rotational speed displayed to zero during the coasting traveling. During the coasting traveling, the vehicle gently decelerates after traveling at a constant vehicle speed. At this time, if the rotational speed of the internal combustion engine is displayed just as it is upon the rotational speed display device, then the rotational speed displayed will fluctuate depending on execution of the rotational speed control and prohibition of this execution. Due to this, there is a possibility that the driver may experience a sense of discomfort. However, according to this embodiment, since during the coasting traveling the display upon the rotational speed display device is set to zero, accordingly it is possible to prevent the rotational speed displayed upon the rotational speed display device during the coasting traveling from fluctuating. Due to this, it is possible to prevent the driver from experiencing any sense of discomfort.

In yet another embodiment of the travel control apparatus of the present invention, the vehicle may further comprise a transmission which includes a single pinion type planetary gear mechanism which is provided as the differential mechanism, a first single pinion type planetary gear mechanism for speed conversion, and a second single pinion type planetary gear mechanism for speed conversion, wherein: a ring gear of the planetary gear mechanism may be connected to an output shaft of the internal combustion engine; a sun gear of the planetary gear mechanism and a ring gear of the first planetary gear mechanism for speed conversion may be connected to a rotor of the first motor-generator; a carrier of the planetary gear mechanism and a carrier of the first planetary gear mechanism for speed conversion may be connected together via a rotating member; a sun gear of the first planetary gear mechanism for speed conversion, a sun gear of the second planetary gear mechanism for speed conversion, and a rotor of the second motor-generator may be connected together via a linking member; a carrier of the second planetary gear mechanism for speed conversion may be connected to an output member which outputs power to the drive wheel; a first brake device may be provided to and be capable of braking, a ring gear of the second planetary gear mechanism for speed conversion; a second brake device may be provided to and is capable of braking the linking member; the carrier of the first planetary gear mechanism for speed conversion and the linking member may be connected together via a first clutch device which is configured to be changed over between an engaged state in which the carrier of the first planetary gear mechanism and the linking member are linked together so as to rotate together, and a disengaged state in which this linking is cancelled; the output member and the rotating member may be connected together via a second clutch device which is configured to be changed over between an engaged state in which the rotating member and the output member are linked together so that they rotate together, and a disengaged state in which this linking is cancelled; and the transmission may be allowed to be changed over between a low speed mode in which, along with the ring gear of the second planetary gear mechanism for speed conversion being braked by the first brake device, the second clutch device is changed over to the disengaged state, and a high speed mode in which, along with the braking of the ring gear of the second planetary gear mechanism for speed conversion by the first brake device being released, the second clutch device is changed over to the engaged state. The present invention can also be applied to a vehicle whose transmission mode can be changed over in this manner.

In the above embodiment, a speed at which the rotational speed of the first motor-generator becomes zero may be set as the control determination speed. As is per se known, if the rotational speed of a motor-generator is zero, then the energy loss in that motor generator becomes minimum. Due to this, even if this type of speed is set as the control determination speed, it is possible to improve the overall energy efficiency of the vehicle in an appropriate manner.

### BRIEF DESCRIPTION OF DRAWINGS

FIG. 1 is a figure schematically showing a vehicle to which a travel control apparatus according to a first embodiment of the present invention is installed;

FIG. 2 is a figure showing an example of an alignment chart for the vehicle during coasting traveling when the vehicle speed is low;

FIG. 3 is a figure showing an example of an alignment chart for the vehicle during coasting traveling when the vehicle speed is high;

FIG. 4 is a figure showing examples of relationships between the vehicle speed and energy loss when rotational speed control is executed, and examples of relationships between vehicle speed and energy loss when rotational speed control is not executed;

FIG. 5 is a flow chart showing an engine rotational speed control routine that is executed by a vehicle control apparatus;

FIG. 6 is a figure schematically showing a vehicle to which a travel control apparatus according to a second embodiment of the present invention is installed;

FIG. 7 is a figure showing a correspondence relationship between states of a first clutch, a second clutch, a first brake, and a second brake, and transmission speed stages;

FIG. 8 is a figure showing examples of alignment charts for the transmission in each of the speed stages;

FIG. 9 is a figure showing an example of an alignment chart for the vehicle during coasting traveling when the transmission is in a low speed mode, and when the speed of the vehicle is low;

FIG. 10 is a figure showing an example of an alignment chart for the vehicle during coasting traveling when the transmission is in a low speed mode, and when the speed of the vehicle is medium;

FIG. 11 is a figure showing an example of an alignment chart for the vehicle during coasting traveling when the transmission is in a low speed mode, and when the speed of the vehicle is high;

FIG. 12 is a figure showing an example of an alignment chart for the vehicle during coasting traveling when the transmission is in a high speed mode, and when the speed of the vehicle is low;

FIG. 13 is a figure showing an example of an alignment chart for the vehicle during coasting traveling when the transmission is in a high speed mode, and when the speed of the vehicle is medium; and

FIG. 14 is a figure showing an example of an alignment chart for the vehicle during coasting traveling when the transmission is in a high speed mode, and when the speed of the vehicle is high.

### DESCRIPTION OF EMBODIMENTS

### Embodiment #1

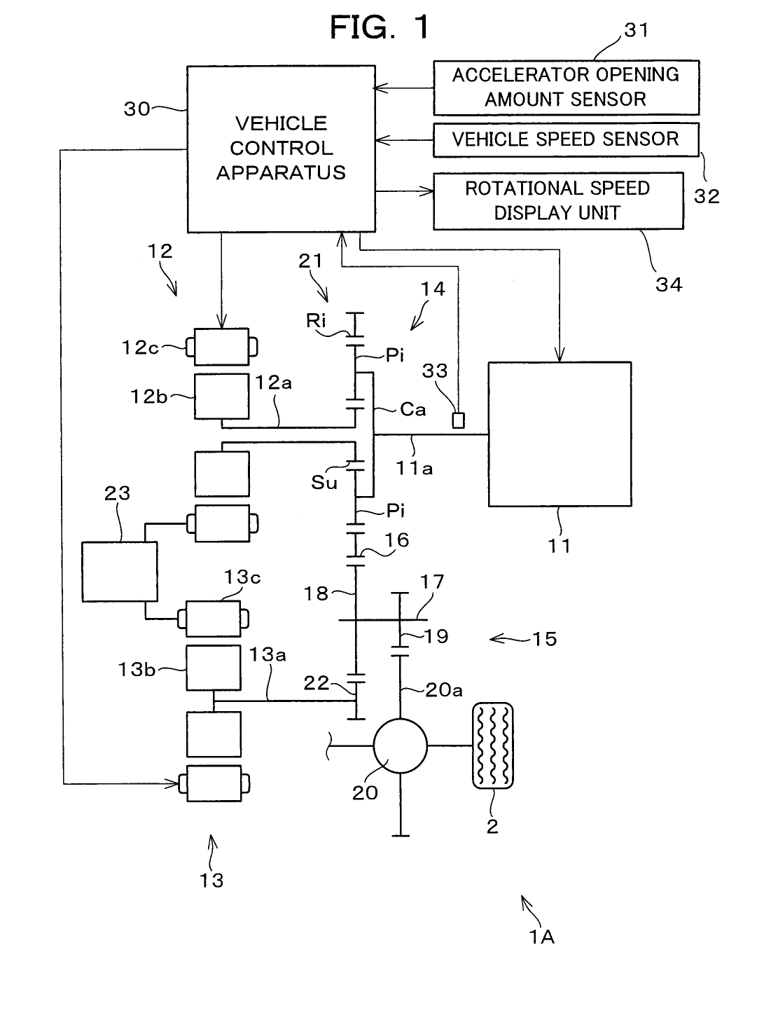

FIG. 1 schematically shows a vehicle to which a travel control apparatus according to a first embodiment of the present invention is installed. This vehicle 1A is configured as a so-called hybrid vehicle. The vehicle 1A comprises an internal combustion engine 11 (sometimes abbreviated herein as the “engine”), a first motor-generator 12 (sometimes abbreviated herein as the “first MG”), and a second motor-generator 13 (sometimes abbreviated herein as the “second MG”). Detailed explanation of the engine 11 will be omitted, since it is an example of a per se known unit for mounting to a hybrid vehicle. And the first MG 12 and the second MG 13 are per se known motor-generators that function both as electric motors and as generators. The first MG 12 comprises a rotor 12b that rotates integrally with an output shaft 12a, and a stator 12c that is disposed coaxially with the external surface of the rotor 12b and is fixed to a casing (not shown in the figures). In a similar manner, the second MG 13 comprises a rotor 13b that rotates integrally with an output shaft 13a, and a stator 13c that is disposed coaxially with the external surface of the rotor 13b and is fixed to a casing.

The output shaft 11a of the engine 11 and the output shaft 12a of the first MG 12 are connected to a power split mechanism 14. An output unit 15 for transmitting power to drive wheels 2 of the vehicle 1A is also connected to the power split mechanism 14. This output unit 15 comprises a first drive gear 16, a counter gear 18 that is meshed with the first drive gear 16 and is fixed to a counter shaft 17, and an output gear 19 that is fixed to the counter shaft 17. This output gear 19 is meshed with a ring gear 20a that is provided to the casing of a differential mechanism 20. The differential mechanism 20 is a per se known mechanism that allocates power transmitted to the ring gear 20a between the left and right drive wheels 2. It should be understood that only one of the left and right drive wheels 2 is shown in FIG. 1.

The power split mechanism 14 includes a planetary gear mechanism 21 that serves as a differential mechanism. This planetary gear mechanism 21 is a single pinion type planetary gear mechanism, and comprises a sun gear Su that is an externally toothed gear wheel, a ring gear Ri that is disposed coaxially with this sun gear Su and that is an internally toothed gear wheel, and a carrier Ca that rotatably carries a pinion gear Pi meshed with these gears Su and Ri so as to revolve around the circumference of the sun gear Su. The sun gear Su is linked to the output shaft 12a of the first MG 12. The carrier Ca is linked to the output shaft 11a of the engine 11. And the ring gear Ri is linked to the first drive gear 16. Due to this, the sun gear Su corresponds to the “second rotation element” of the present invention, the carrier Ca corresponds to the “first rotation element” of the present invention, and the ring gear Ri corresponds to the “third rotation element” of the present invention.

As shown in this figure, a second drive gear 22 is provided on the output shaft 13a of the second MG 13. This second drive gear 22 is meshed with the counter gear 18. The first MG 12 and the second MG 13 are electrically connected to a battery 23 via inverters and boost converters not shown in the figures

The operation of the engine 11, of the first MG 12, and of the second MG 13 is controlled by a vehicle control apparatus 30. This vehicle control apparatus 30 is built as a computer unit that includes a microprocessor and peripheral devices such as RAM, ROM and so on that are necessary for its operation. The vehicle control apparatus 30 stores control programs of various types for causing the vehicle 1A to travel in an appropriate manner. The vehicle control apparatus 30 performs control of control objects such as the engine 11 and the MGs 12 and 13 and so on by executing these programs. Various sensors for acquiring information related to the vehicle 1A are connected to the vehicle control apparatus 30. For example, an accelerator opening amount sensor 31, a vehicle speed sensor 32, and a crank angle sensor 33 are connected to the vehicle control apparatus 30. The accelerator opening amount sensor 31 outputs a signal that corresponds to the amount by which an accelerator pedal is stepped upon, in other words to an accelerator opening amount. The vehicle speed sensor 32 outputs a signal that corresponds to the speed of the vehicle 1A (i.e. to the vehicle speed). And the crank angle sensor 33 outputs a signal that corresponds to the rotational speed of the output shaft 11a of the engine 11 (i.e. to its rpm).

Moreover, a rotational speed display unit 34 is connected to the vehicle control apparatus 30, and serves as a rotational speed display device. The rotational speed display unit 34 displays the rotational speed that is outputted from the vehicle control apparatus 30. For example, the rotational speed of the engine 11 may be displayed upon this rotational speed display unit 34. Moreover, apart from the above, various sensors and switches and so on are connected to the vehicle control apparatus 30, but these are not shown in the figures.

A plurality of travelling modes are provided for the vehicle 1A. For example, as this plurality of travelling modes, a steady travelling mode and an accelerating-coasting travelling mode may be set. In the steady travelling mode, the engine 11, the first MG 12, and the second MG 13 are controlled so that the vehicle 1A travels at a constant speed. And in the accelerating-coasting travelling mode, the engine 11, the first MG 12, and the second MG 13 are controlled so that accelerating traveling sections and coasting travelling sections are performed repeatedly and alternatingly. In the accelerating traveling sections of the accelerating-coasting travelling mode, the engine 11 is in its operational state, and the vehicle 1A is accelerated by the drive wheels 2 being driven with the power of the engine 11. Moreover, in these accelerating traveling sections, a constant level of power is outputted from the engine 11, and also the acceleration of the vehicle 1A is set so that the rotational speed of the first MG 12 becomes zero. On the other hand, in the coasting traveling sections of the accelerating-coasting travelling mode, the engine 11 is stopped. And, the vehicle 1A is made to perform coasting traveling. In this case, the vehicle 1A decelerates due to traveling resistance. In this accelerating-coasting travelling mode, a target vehicle speed region is set on the basis of the speed that is being requested for the vehicle 1A (i.e. the requested speed). And the accelerating traveling and the coasting traveling, in other words acceleration and deceleration of the vehicle 1A, are performed repeatedly and alternatingly within this target vehicle speed region.

The vehicle control apparatus 30 changes over between these traveling modes on the basis of the running state of the vehicle 1A. For example, the vehicle control apparatus 30 may change over the traveling mode to the accelerating-coasting traveling mode if a predetermined condition for accelerating-coasting traveling becomes valid. It should be understood that whether or not the condition for accelerating-coasting traveling has become valid may, for example, be determined on the basis of the vehicle speed and its acceleration or deceleration. In concrete terms, it may be determined that the accelerating-coasting travel condition has become valid if, along with the vehicle speed being greater than or equal to a predetermined high speed determination speed, also during a predetermined interval the vehicle speed has been almost constant, and moreover during this predetermined interval there has been almost no acceleration or deceleration of the vehicle 1A. By changing over the traveling mode in this manner, the vehicle control apparatus 30 functions as the “accelerating-coasting travel device” of the Claims.

Moreover if, during coasting traveling, the vehicle speed is greater than or equal to a predetermined control determination speed, then the vehicle control apparatus 30 controls the first MG 12 so that the rotational speed of the engine 11 reaches a predetermined motor drive rotational speed. In the following, this control will be termed “rotational speed control”. It should be understood that the motor drive rotational speed is set to a rotational speed that is higher than zero. In concrete terms, this rotational speed may be set to 100 to 500 rpm. On the other hand if, during coasting traveling, the vehicle speed is less than the control determination speed, then the execution of rotational speed control is prohibited. In this case, the first MG 12, the second MG 13, and the boost converters are shut down. Due to this, the rotational speed and the output torque of the engine 11 become zero.

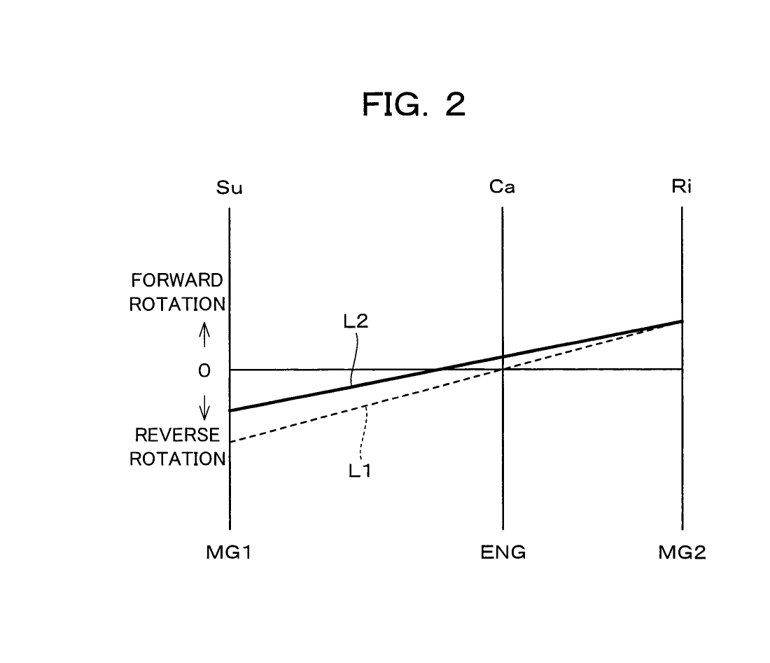

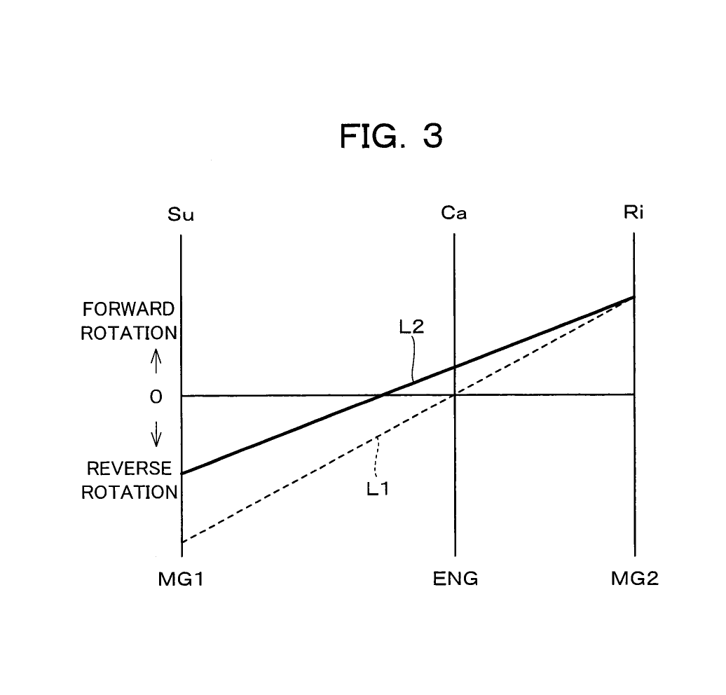

FIGS. 2 and 3 give examples of alignment charts for the vehicle 1A during coasting traveling. It should be understood that FIG. 2 shows an alignment chart for when the vehicle speed is low, while FIG. 3 shows an alignment chart for when the vehicle speed is high. In these figures, “MG1” denotes the first MG 12, “ENG” denotes the engine 11, and “MG2” denotes the second MG 13. Moreover, “Su”, “Ca”, and “Ri” respectively denote the sun gear Su, the carrier Ca, and the ring gear Ri of the planetary gear mechanism 21. In these figures, the forward rotational direction is the direction in which the engine 11 rotates during operation. Conversely, the reverse rotational direction is the opposite direction to this forward rotational direction. And the broken line L1 shows the relationship between these rotating elements when rotational speed control is not executed. Moreover, the solid line L2 shows the relationship between these rotating elements when rotational speed control is executed.

As will be clear from FIG. 1, during coasting traveling, the ring gear Ri and the second MG 13 rotate due to power inputted from the drive wheels 2. Due to this, if the rotational speed of the engine 11 is zero, then the first MG 12 rotates in the reverse rotational direction. And, since in this case the rotational speed of the ring gear Ri becomes high when the vehicle speed is high, accordingly the sun gear Su and the first MG 12 rotate at high speed. With a per se known motor-generator, magnetism is generated by the rotor when the rotor rotates. Therefore energy loss occurs in the motor-generator, since the rotor is braked by this magnetism. And the higher is the rotational speed of the rotor, the greater this magnetism becomes. Due to this, if the rotational speed of the engine 11 is zero, the energy losses in the first MG 12 and the second MG 13 become greater, the higher is the vehicle speed. Moreover, mechanical losses also occur due to frictional losses in the mechanical portions provided to the MGs 12 and 13, such as the bearings of their rotors and so on. And these mechanical losses also become higher, the higher are the rotational speeds of the rotors. Furthermore, when the cooling oil in the MGs 12 and 13 is churned, stirring losses (also termed drag losses) occur. These stirring losses also become greater, the higher is the rotational speed of the rotor. Moreover with a planetary gear mechanism, as is per se known, the greater the frictional losses become, the greater the differences in rotational speeds between the various rotating elements become. Due to the above, if the rotational speed of the engine is kept at zero, the energy losses in the planetary gear mechanism 21 become greater, the higher is the vehicle speed.

In this manner, when the rotational speed of the engine 11 is zero, the greater the vehicle speed is, the greater are the energy losses in the first MG 12, in the second MG 13, and in the planetary gear mechanism 21. By contrast, when rotational speed control is executed, as shown in FIGS. 2 and 3, the rotational speed of the first MG 12 and the rotational speed of the sun gear Su are reduced. In particular, if the vehicle speed is high, then the rotational speed of the first MG 12 and the rotational speed of the sun gear Su are greatly reduced, as compared to the case when the vehicle speed is low. Due to this, it is possible to reduce the energy loss in the first MG 12 and the energy loss in the planetary gear mechanism 21. However, in this case, frictional losses do still occur in the engine 11, since the engine 11 is rotating.

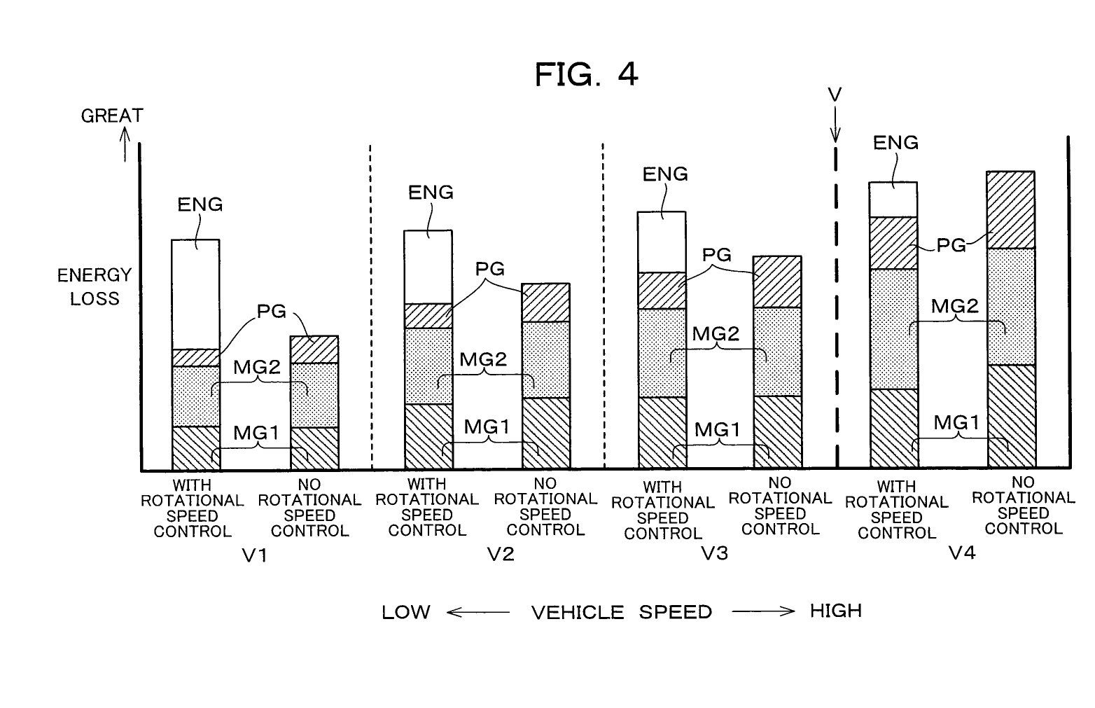

FIG. 4 shows examples of relationships between the vehicle speed and the energy loss of the vehicle 1A when the rotational speed control is executed, and the energy loss of the vehicle 1A when the rotational speed control is not executed. It should be understood that “ENG” in this figure denotes the frictional loss in the engine 11. Moreover, “MG1” denotes the energy loss in the first MG 12. And “MG2” denotes the energy loss in the second MG 13. Furthermore, “PG” denotes the energy loss in the planetary gear mechanism 21. It should be understood that, while energy losses also occur in portions of the vehicle 1A other than these, these energy losses are not shown in the figure, since they are small as compared with the energy losses in the engine 11, in the first MG 12, in the second MG 13, and in the planetary gear mechanism 21. The vehicle speeds in this figure are in the relationship V1<V2<V3<V4.

As shown in this figure, if the vehicle speed is any of the speeds V1 through V3, then the energy losses of the vehicle 1A are smaller when the rotational speed control is not executed. On the other hand, if the vehicle speed is the speed V4, then the energy loss is smaller when the rotational speed control is executed. This means that, with this vehicle 1A, when the vehicle speed becomes greater than or equal to some predetermined vehicle speed V which is between the vehicle speed V3 and the vehicle speed V4 shown in FIG. 4, then the energy loss when the rotational speed control is not executed becomes greater than the energy loss when the rotational speed control is executed. Due to this, it is favorable to set this vehicle speed V as the control determination speed for determining whether or not the rotational speed control is to be executed. It should be understood that the control determination speed is not limited to being this vehicle speed V. For example, it would also be acceptable to arrange to set a vehicle speed that is higher than this vehicle speed V as the control determination speed. Alternatively, as the control determination speed, it would also be acceptable to set an appropriate vehicle speed at which the energy loss if the rotational speed control is not executed becomes greater than the energy loss if the rotational speed control is executed. For example, the control determination speed may be set to a speed in a high speed region where the first MG 12 rotates reversely.

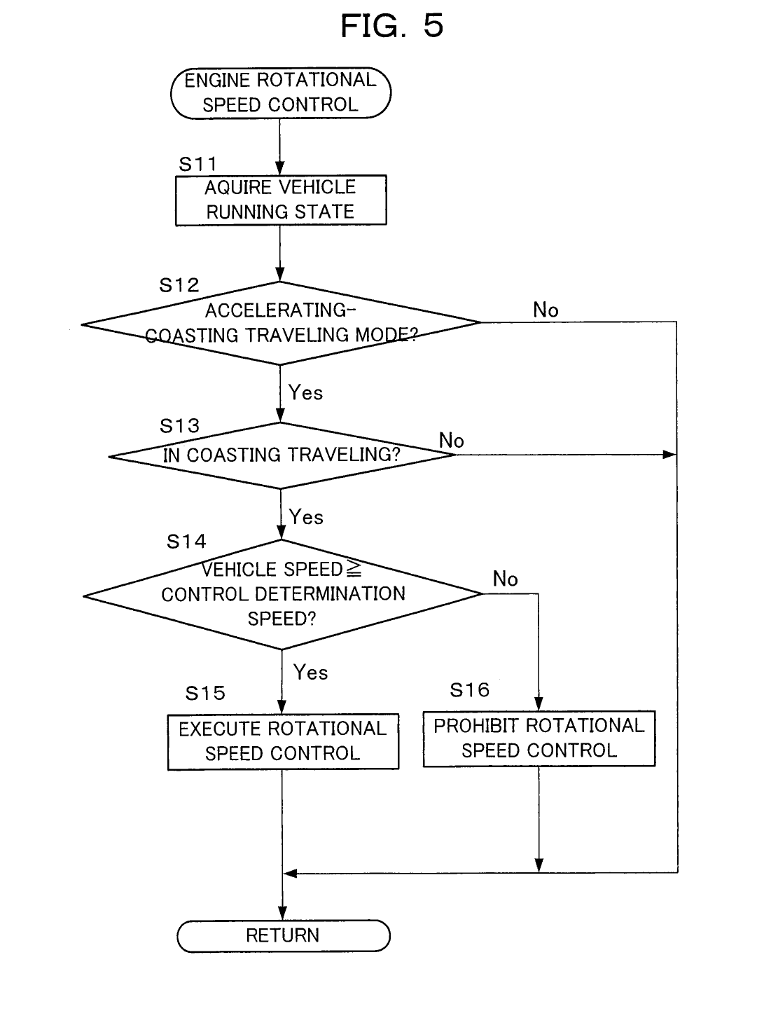

FIG. 5 shows an engine rotational speed control routine that is executed by the vehicle control apparatus 30 in order to control the rotational speed of the engine 11 during coasting traveling in this manner. This control routine is repeatedly executed on a predetermined cycle while the vehicle 1A is traveling. By executing this control routine, the vehicle control apparatus 30 functions as the “control device” of the present invention.

In this control routine, in first step S11 the vehicle control apparatus 30 acquires the running state of the vehicle 1A. As the state of the vehicle 1A, for example, the accelerator opening amount, the vehicle speed, and the rotational speed of the engine 11 may be acquired. While various items of information other than the above related to the running state of the vehicle 1A may be acquired in this step, explanation thereof will herein be omitted.

In the next step S12, the vehicle control apparatus 30 determines as to whether or not the traveling mode is the accelerating-coasting traveling mode. If it is determined that the traveling mode is not the accelerating-coasting traveling mode, then this cycle of the routine terminates. On the other hand, if determining that the traveling mode is the accelerating-coasting traveling mode, then the vehicle control apparatus 30 goes to step S13 to determine as to whether or not, at the present time, the vehicle is performing the coasting traveling. If it is determined that at the present time the vehicle is performing the accelerating traveling, then this cycle of the routine terminates.

On the other hand, if determining that at the present time the vehicle is performing the coasting traveling, then the vehicle control apparatus 30 goes to step S14 to determine as to whether or not the current vehicle speed is greater than or equal to the control determination speed. If determining that the vehicle speed is greater than or equal to the control determination speed, then the vehicle control apparatus 30 goes to step S15 to execute the rotational speed control. Moreover, in this processing, zero is displayed upon the rotational speed display unit 34. Then this cycle of the routine terminates. On the other hand, if determining that the current vehicle speed is less than the control determination speed, then the vehicle control apparatus 30 goes to step S16 to prohibit the execution of the rotational speed control. Moreover, in this processing also, zero is displayed upon the rotational speed display unit 34. In other words, zero is displayed upon the rotational speed display unit 34 during coasting traveling. And then this cycle of the routine terminates.

As has been explained above, according to this first embodiment, since during coasting traveling the rotational speed control is executed when the vehicle speed becomes greater than or equal to the control determination speed, accordingly it is possible to reduce the energy loss of the vehicle 1A during coasting traveling. Since, due to this, it is possible to improve the overall energy efficiency of the vehicle 1A during coasting traveling, accordingly it is possible to increase the distance that the vehicle 1A can travel with coasting traveling. And, due to this, it is possible to enhance the fuel consumption.

Moreover, zero is displayed upon the rotational speed display unit 34 during coasting traveling. During coasting traveling, the vehicle gently decelerates after traveling at a constant speed. At this time, if the rotational speed of the engine 11 were to be displayed upon the rotational speed display unit 34 just as it is, then the rotational speed that is being displayed would fluctuate along with rotational speed control being executed and execution thereof being prohibited. Due to this, there is a possibility that the driver might experience a sense of discomfort. However since, with the present invention, zero is displayed upon the rotational speed display unit 34 during coasting traveling, accordingly it is possible to prevent the rotational speed that is displayed upon the rotational speed display unit 34 during coasting traveling from fluctuating. Due to this, it is possible to prevent the driver from experiencing any sense of discomfort.

### Embodiment #2

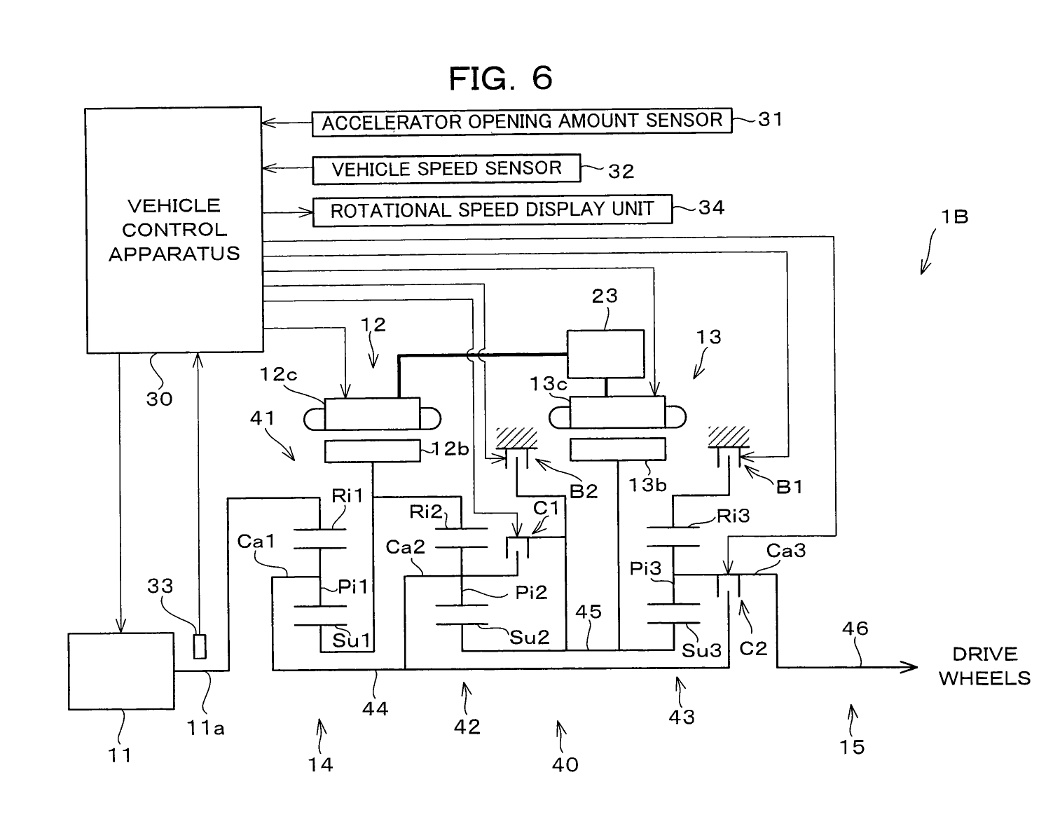

Next, a travel control apparatus according to a second embodiment of the present invention will be explained with reference to FIGS. 6 through 14. FIG. 6 schematically shows a vehicle 1B to which this travel control apparatus according to the second embodiment is installed. It should be understood that, in these figures, portions that are the same as portions in FIG. 1 are denoted by the same reference symbols, and explanation thereof is omitted.

As shown in this figure, a transmission 40 is provided to the vehicle 1B. And the engine 11, the first MG 12, and the second MG 13 are connected to this transmission 40. The transmission 40 comprises a first planetary gear mechanism 41, a second planetary gear mechanism 42, and a third planetary gear mechanism 43. All of these planetary gear mechanisms 41, 42, and 43 are built as single pinion type planetary gear mechanisms. The first planetary gear mechanism 41 comprises a sun gear Su1 that is an externally toothed gear wheel, a ring gear Ri1 that is disposed coaxially with this sun gear Su1 and that is an internally toothed gear wheel, and a carrier Ca1 that rotatably carries a pinion gear Pi1 meshed with these gears Su1 and Ri1 so as to revolve around the circumference of the sun gear Su1. In the following, the sun gear Su1, the ring gear Ri1, and the carrier Ca1 of this first planetary gear mechanism 41 will sometimes be referred to as the first sun gear Su1, the first ring gear Ri1, and the first carrier Ca1.

The second planetary gear mechanism 42 comprises a sun gear Su2 that is an externally toothed gear wheel, a ring gear Ri2 that is disposed coaxially with this sun gear Su2 and that is an internally toothed gear wheel, and a carrier Ca2 that rotatably carries a pinion gear Pi2 meshed with these gears Su2 and Ri2 so as to revolve around the circumference of the sun gear Su2. In the following, the sun gear Su2, the ring gear Ri2, and the carrier Ca2 of this second planetary gear mechanism 42 will sometimes be referred to as the second sun gear Su2, the second ring gear Ri2, and the second carrier Ca2.

And the third planetary gear mechanism 43 comprises a sun gear Su3 that is an externally toothed gear wheel, a ring gear Ri3 that is disposed coaxially with this sun gear Su3 and that is an internally toothed gear wheel, and a carrier Ca3 that rotatably carries a pinion gear Pi3 meshed with these gears Su3 and Ri3 so as to revolve around the circumference of the sun gear Su3. In the following, the sun gear Su3, the ring gear Ri3, and the carrier Ca3 of this third planetary gear mechanism 43 will sometimes be referred to as the third sun gear Su3, the third ring gear Ri3, and the third carrier Ca3.

The first ring gear Ri1 is linked to the output shaft 11a of the engine 11. And the first sun gear Su1 and the second ring gear Ri2 are linked to the rotor 12b of the first MG 12. The first carrier Ca1 and the second carrier Ca2 are linked to a rotation shaft 44 which serves as a rotating member. The second sun gear Su2 and the third sun gear Su3 are linked to the rotor 13b of the second MG 13 via a link shaft 45, which serves as a linking member. This link shaft 45 is also linked to the second carrier Ca2 via a first clutch C1. This first clutch C1 is capable of changing over between an engaged state in which the second carrier Ca2 and the link shaft 45 rotate together with one another, and a disengaged state in which the second carrier Ca2 is disengaged from the link shaft 45. The third carrier Ca3 is linked to an output shaft 46 that serves as an output member. Although this feature is not shown in the figure, the output shaft 46 is connected to drive wheels 2 via a differential mechanism 20. And the output shaft 46 is linked to the rotation shaft 44 via a second clutch C2. This second clutch C2 is capable of changing over between an engaged state in which the output shaft 46 and the rotation shaft 44 rotate together with one another, and a disengaged state in which the rotation shaft 44 is disengaged from the output shaft 46. A first brake B1 is provided to the third ring gear Ri3, and is capable of changing over between a braking state in which it brakes the third ring gear Ri3, and a released state in which this braking is released. Moreover, a second brake B2 is provided to the link shaft 45, and is capable of changing over between a braking state in which it brakes the link shaft 45, and a released state in which this braking is released.

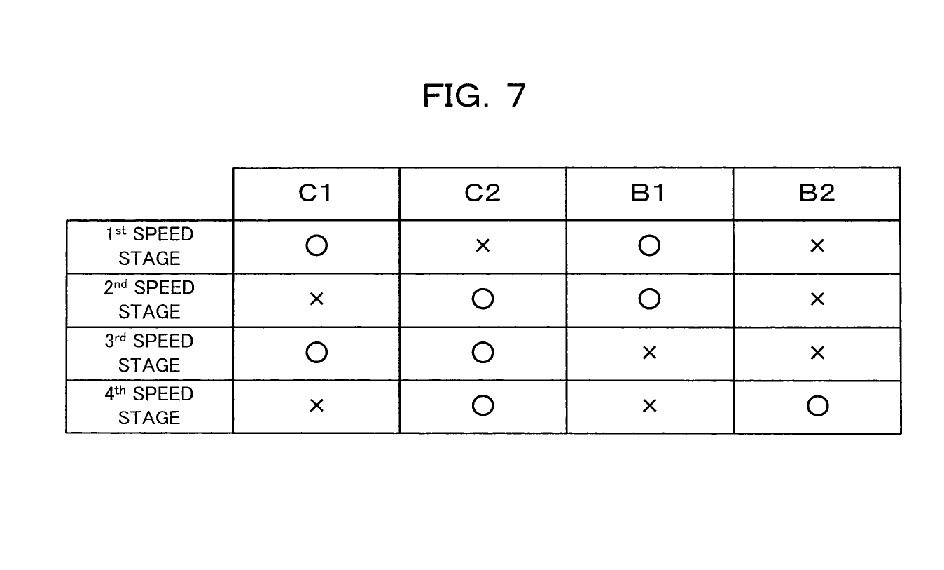

With this transmission 40, changeover between various speed stages is performed by changing over the states of the first clutch C1, of the second clutch C2, of the first brake B1, and of the second brake B2 as appropriate. FIG. 7 shows the correspondence relationship between the states of the first clutch 45, of the second clutch 49, of the first brake 46, and of the second brake 47 and the speed stages. “C1” in this figure denotes the first clutch C1, while “C2” denotes the second clutch C2. Moreover, “0” for each of these clutches C1 and C2 means that the corresponding clutch is in the engaged state. On the other hand, “x” for each of these clutches C1 and C2 means that the corresponding clutch is in the disengaged state. And “B1” in this figure denotes the first brake B1, while “B2” denotes the second brake B2. Moreover, “∘” for each of these brakes B1 and B2 means that the corresponding brake is in the braking state. On the other hand, “x” for each of these brakes B1 and B2 means that the corresponding brake is in the released state. As shown in this figure, the transmission 40 can be changed over between four speed stages, i.e. a first speed stage through a fourth speed stage.

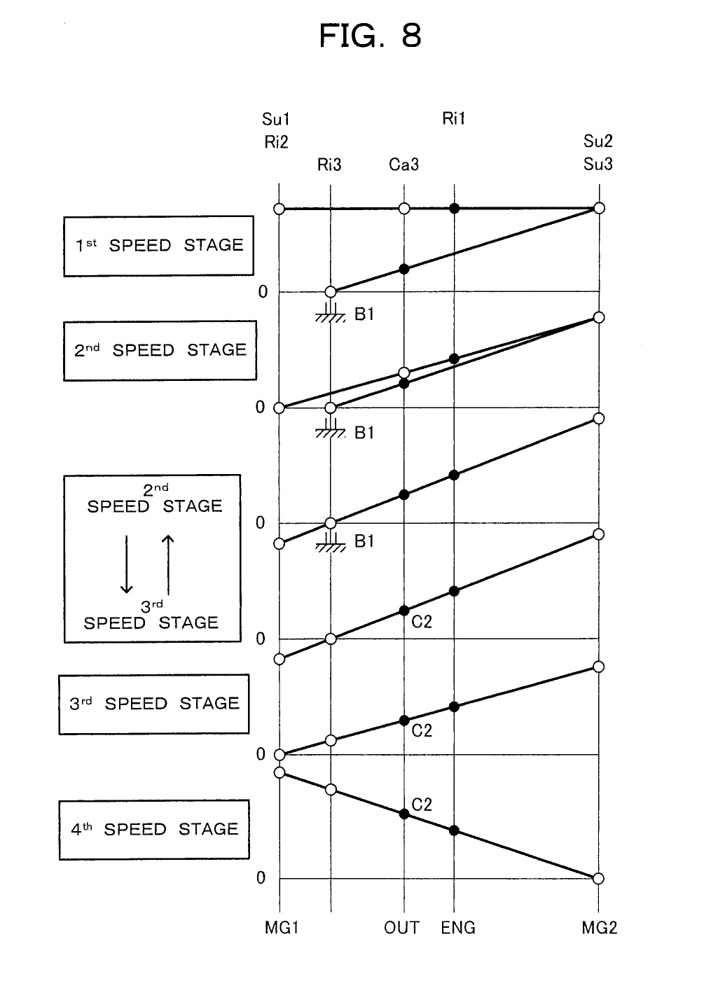

FIG. 8 shows examples of alignment charts for the transmission 40 in each of the speed stages. It should be understood that, in these figures, “MG1” denotes the first MG 12, “ENG” denotes the engine 11, “MG2” denotes the second MG 13, and “OUT” denotes the output shaft 46. Moreover, “Su1”, “Ca1”, and “Ri1” respectively denote the first sun gear Su1, the first carrier Ca1, and the first ring gear Ri1. And “Su2”, “Ca2”, and “Ri2” respectively denote the second sun gear Su2, the second carrier Ca2, and the second ring gear Ri2. Furthermore, “Su3”, “Ca3”, and “Ri3” respectively denote the third sun gear Su3, the third carrier Ca3, and the third ring gear Ri3. And “B1” denotes the first brake B1, while “C2” denotes the second clutch C2.

As shown in this figure, in the first speed stage and the second speed stage, the first brake B1 is put into the braking state, while the second clutch C2 is put into the disengaged state. At this time, the first carrier Ca1 and the second carrier Ca2 are disengaged from the output shaft 46. Due to this, there are two lines in the alignment chart for showing the relationship between the rotational speeds of these rotating elements. And in this case the speed conversion ratio is high, since the power of the engine 11 is transmitted to the output shaft 46 via the planetary gear mechanisms 41 through 43. Subsequently, in some cases, the first speed stage and the second speed stage will together be referred to as the “low speed mode”. On the other hand, in the third speed stage and the fourth speed stage, the first brake B1 is put into the released state, while the second clutch C2 is put into the engaged state. At this time, the first carrier Ca1, the second carrier Ca2, and the output shaft 46 rotate together integrally. Due to this, there is a single line in the alignment chart for showing the relationship between the rotational speeds of these rotating elements. And in this case the speed conversion ratio is low, since the power of the engine 11 is transmitted to the output shaft 46 via the first planetary gear mechanism 41. Subsequently, in some cases, the third speed stage and the fourth speed stage will together be referred to as the “high speed mode”.

It should be understood that, in the changeover from the second speed stage to the third speed stage, the engine 11, the first MG 12, and the second MG 13 are controlled so that the two lines specifying the relationship of the rotational speeds of the rotation elements coincide, and, when these two lines coincide, the first brake B1 is put into the released state while the second clutch C2 is put into the engaged state. On the other hand, in the changeover from the third speed stage to the second speed stage, the engine 11, the first MG 12, and the second MG 13 are controlled so that the rotational speed of the third ring gear Ri3 becomes zero, and, when the rotational speed of the third ring gear Ri3 becomes zero, the first brake B1 is put into the braking state while the second clutch C2 is put into the disengaged state.

The operation of the first clutch C1, of the second clutch C2, of the first brake B1, and of the second brake B2 is controlled by the vehicle control apparatus 30. The vehicle control apparatus 30 controls these clutches C1 and C2 and these brakes B1 and B2 on the basis of the accelerator opening amount and the vehicle speed, and, due to this, the speed stage is changed over as appropriate.

With this vehicle 1B as well, as traveling modes, both the steady traveling mode and the accelerating-coasting traveling mode are provided. And, in a similar manner to the case with the first embodiment, the vehicle control apparatus 30 executes the accelerating-coasting traveling mode when the accelerating-coasting traveling condition has become valid. Moreover, in this embodiment as well, the vehicle control apparatus 30 executes the control routine shown in FIG. 5. Due to this, during coasting traveling, the rotational speed control is executed when the vehicle speed becomes greater than or equal to a predetermined control determination speed that is set in advance.

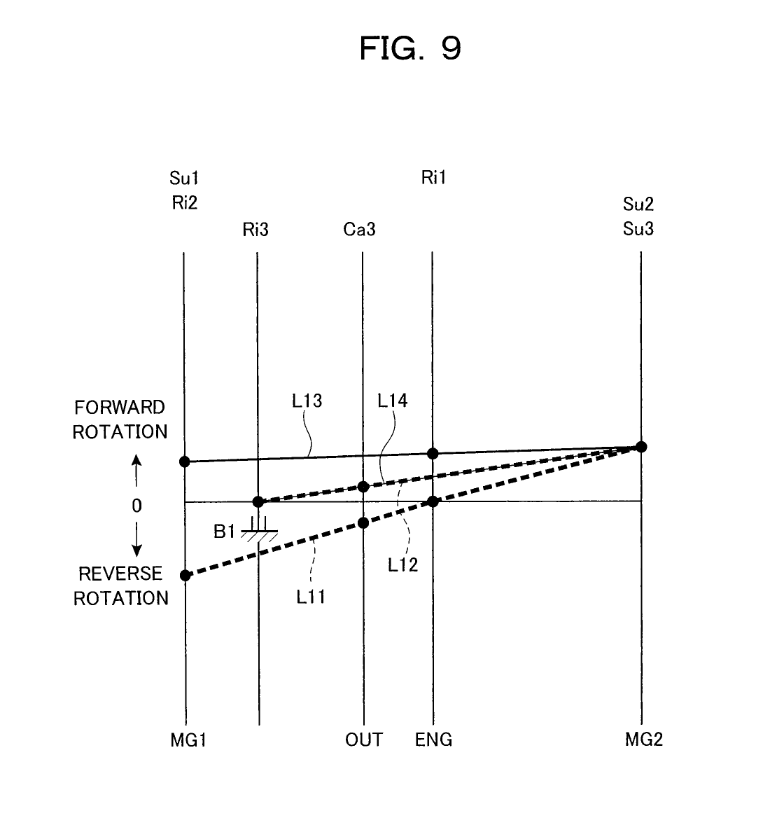

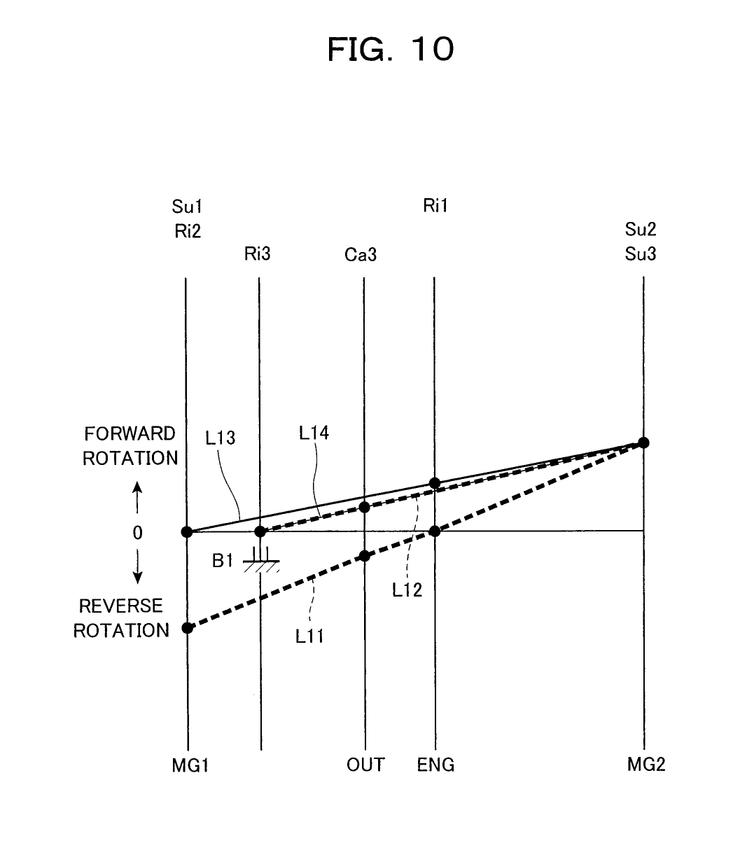

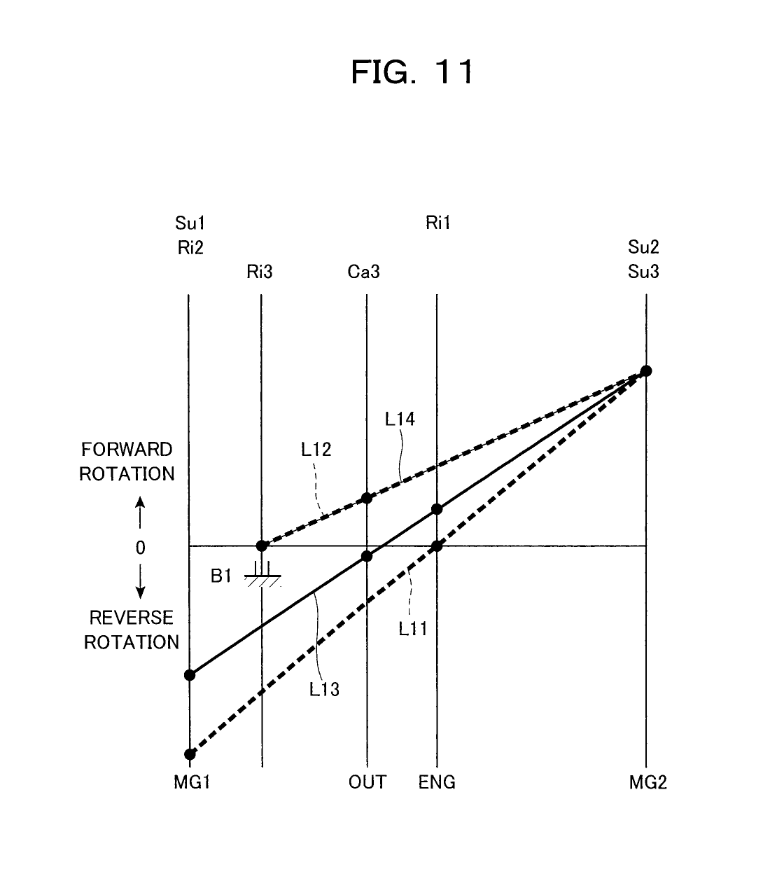

FIGS. 9 through 11 show alignment charts for the vehicle 1B during coasting traveling, when the transmission 40 is in the low speed mode. FIG. 9 shows an alignment chart during low speed. And FIG. 10 shows an alignment chart during medium speed. Moreover, FIG. 11 shows an alignment chart during high speed. It should be understood that, as described above, when the transmission 40 is in the low speed mode, there are two lines in these alignment charts showing the relationships between the rotational speeds of the rotation elements. Due to this, the broken lines L11 and L12 in the figures show the relationships between the rotation elements when the rotational speed control is not being executed. And the solid lines L13 and L14 show the relationships between the rotation elements when the rotational speed control is being executed.

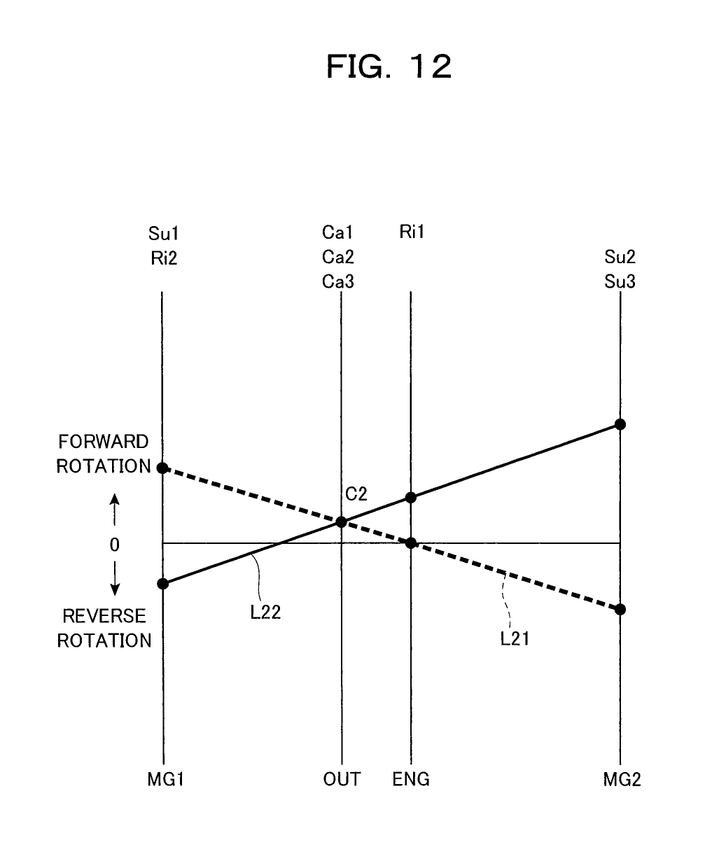

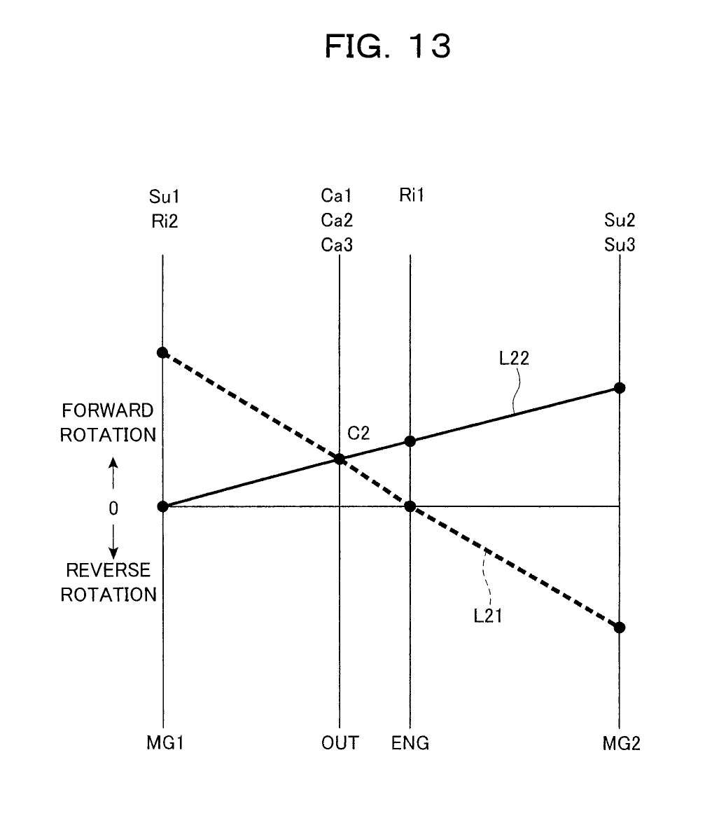

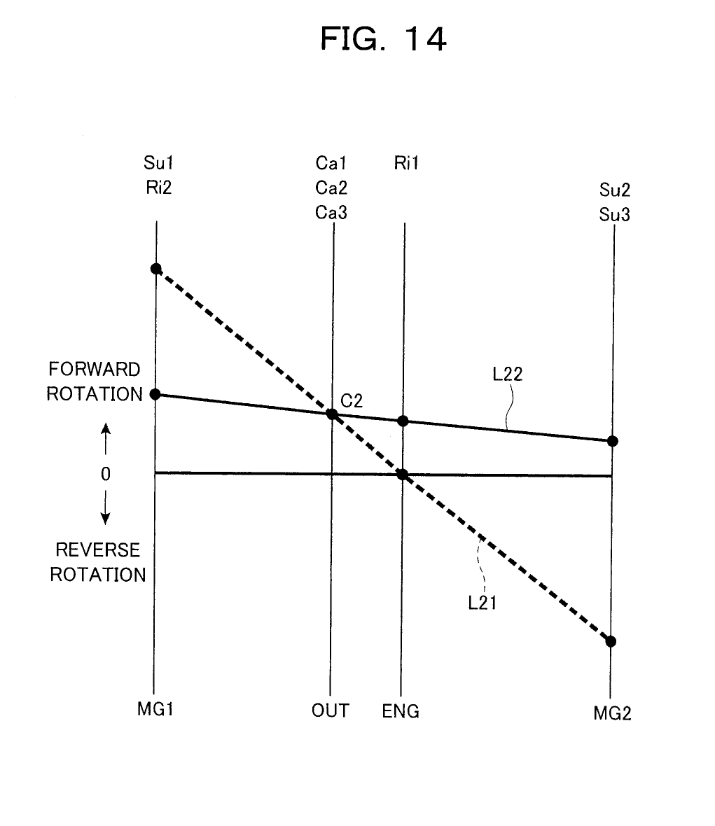

And FIGS. 12 through 14 show alignment charts for the vehicle 1B during coasting traveling, when the transmission 40 is in the high speed mode. FIG. 12 shows an alignment chart during low speed. And FIG. 13 shows an alignment chart during medium speed. Moreover, FIG. 14 shows an alignment chart during high speed. The broken lines L21 in the figures show the relationships between the rotation elements when the rotational speed control is not being executed. And the solid lines L22 show the relationships between the rotation elements when the rotational speed control is being executed.

As shown in these figures, with the vehicle 1B according to this second embodiment, at high speed when the rotational speed control is not being performed, the differences between the rotational speeds of the rotation elements of the planetary gear mechanisms 41, 42, and 43 become large. Moreover, the rotational speeds of the MGs 12 and 13 also become large. Due to this, in circumstances of this kind, the energy losses of the MGs 12 and 13 and the energy losses of the planetary gear mechanisms 41, 42, and 43 all become large. Thus, in circumstances of this kind, the rotational speed control is performed. Due to this, it is possible to make the differences between the rotational speeds of the rotation elements of the planetary gear mechanisms 41, 42, and 43 become small. Moreover, it is possible to reduce the rotational speeds of the MGs 12 and 13.

It should be understood that, the control determination speed is set to a vehicle speed at which the energy loss in a case where the rotational speed control is not executed would become higher than the energy loss in a case where the rotational speed control is executed. Moreover there is a vehicle speed at which, as shown in FIG. 10, when the transmission 40 is in the low speed mode, then the rotational speed of the first MG 12 becomes zero when the rotational speed control is executed. At this operational point at which the rotational speed of the first MG 12 becomes zero in this manner, i.e. at the so-called mechanical point, the energy loss of the first MG 12 becomes minimum. Thus, it would also be acceptable to arrange to set the vehicle speed at which the rotational speed of the first MG 12 becomes zero in this manner, as the control determination speed for the time when the transmission 40 is in the low speed mode. Moreover, as shown in FIG. 13, when the transmission 40 is in the high speed mode as well, there is a vehicle speed at which the rotational speed of the first MG 12 becomes zero when the rotational speed control is executed. Thus, it would also be acceptable to arrange to set this vehicle speed as the control determination speed for the time when the transmission 40 is in the high speed mode.

Since, as has been explained above, in this second embodiment as well, the rotational speed control is executed when the vehicle speed becomes equal to or higher than the control determination speed in coasting traveling, accordingly it is possible to reduce the energy loss of the vehicle 1B during coasting traveling. And since, due to this, it is possible to improve the overall energy efficiency of the vehicle 1B in coasting traveling, accordingly it is possible to increase the distance that the vehicle 1B can travel during coasting traveling. Because of this, it is possible to improve the fuel consumption.

It should be understood that the first planetary gear mechanism 41 corresponds to the “planetary gear mechanism” of the present invention. And the second planetary gear mechanism 42 corresponds to the “first planetary gear mechanism for speed conversion” of the present invention. Moreover, the third planetary gear mechanism 43 corresponds to the “second planetary gear mechanism for speed conversion” of the present invention.

The present invention is not to be considered as being limited to the embodiments described above; it could be implemented in various different embodiments. For example, the condition for executing the rotational speed control is not limited to the case in which, during coasting traveling, the vehicle speed has become greater than or equal to the control determination speed. It would also be acceptable to arrange to execute the rotational speed control if the vehicle speed has become greater than or equal to a control determination speed, when the vehicle is traveling at high speed and moreover requested output to the internal combustion engine is zero.

1. A travel control apparatus applied to a hybrid vehicle, the hybrid vehicle comprising:
an internal combustion engine;
a first motor generator;
an output unit for transmitting power to a drive wheel;
a differential mechanism comprising three rotating elements which are mutually differentially rotatable, with, among the three rotating elements, a first rotating element being connected to the internal combustion engine, a second rotating element being connected to the first motor generator, and a third rotating element being connected to the output unit; and
a second motor generator which is capable of outputting power to the output unit, wherein
the travel control apparatus comprises a computer which is programmed to function as a control device by executing a computer program, the control device being configured to, when a requested output to the internal combustion engine is zero: when speed of the vehicle is greater than or equal to a predetermined control determination speed, control the first motor generator by executing rotational speed control so that the rotational speed of the internal combustion engine is higher than zero; and, when the speed of the vehicle is less than the predetermined control determination speed, control the first motor generator so that execution of the rotational speed control is prohibited, and
the control determination speed is set to a speed at which energy loss of the vehicle occurring when the rotational speed control is not executed is greater than energy loss of the vehicle occurring when the rotational speed control is executed.

2. (canceled)

3. The travel control apparatus according to claim 1, wherein
the computer is further programmed to function as an accelerating-coasting travel device by executing the computer program,
the accelerating-coasting travel device being configured to control the internal combustion engine, the first motor generator, and the second motor generator so that, when if a predetermined accelerating coasting travel condition becomes valid when the vehicle is traveling, the vehicle travels in an accelerating-coasting travelling mode in which accelerating traveling in which the internal combustion engine is put into an operational state at which the vehicle is accelerated with power outputted from the internal combustion engine so that the rotational speed of the first motor generator becomes zero, and coasting traveling in which the internal combustion engine is put into a stopped state and the vehicle is allowed to travel under inertia, are performed repeatedly and alternatingly within a predetermined target vehicle speed region; and
the control device is further configured to control the first motor generator so that the rotational speed control is executed when the speed of the vehicle in the coasting traveling is greater than or equal to the control determination speed, and so that execution of the rotational speed control is prohibited when the speed of the vehicle in the coasting traveling is less than the control determination speed.

4. The travel control apparatus according to claim 3, wherein:
a rotational speed display device which displays the rotational speed of the internal combustion engine is provided to the vehicle; and
the control device is further configured to set the rotational speed displayed to zero during the coasting traveling.

5. The travel control apparatus according to claim 1, wherein the vehicle further comprises a transmission which includes a single pinion type planetary gear mechanism which is provided as the differential mechanism, a first single pinion type planetary gear mechanism for speed conversion, and a second single pinion type planetary gear mechanism for speed conversion, wherein:
a ring gear of the planetary gear mechanism is connected to an output shaft of the internal combustion engine;
a sun gear of the planetary gear mechanism and a ring gear of the first planetary gear mechanism for speed conversion are connected to a rotor of the first motor generator;
a carrier of the planetary gear mechanism and a carrier of the first planetary gear mechanism for speed conversion are connected together via a rotating member;
a sun gear of the first planetary gear mechanism for speed conversion, a sun gear of the second planetary gear mechanism for speed conversion, and a rotor of the second motor generator are connected together via a linking member;
a carrier of the second planetary gear mechanism for speed conversion is connected to an output member which outputs power to the drive wheel;
a first brake device is provided to and is capable of braking, a ring gear of the second planetary gear mechanism for speed conversion;
a second brake device is provided to and is capable of braking the linking member;
the carrier of the first planetary gear mechanism for speed conversion and the linking member are connected together via a first clutch device which is configured to be changed over between an engaged state in which the carrier of the first planetary gear mechanism and the linking member are linked together so as to rotate together, and a disengaged state in which this linking is cancelled;
the output member and the rotating member are connected together via a second clutch device which is configured to be changed over between an engaged state in which the rotating member and the output member are linked together so that they rotate together, and a disengaged state in which this linking is cancelled; and
the transmission is allowed to be changed over between a low speed mode in which, along with the ring gear of the second planetary gear mechanism for speed conversion being braked by the first brake device, the second clutch device is changed over to the disengaged state, and a high speed mode in which, along with the braking of the ring gear of the second planetary gear mechanism for speed conversion by the first brake device being released, the second clutch device is changed over to the engaged state.

6. The travel control apparatus according to claim 5, wherein a speed at which the rotational speed of the first motor generator becomes zero is set as the control determination speed.
